(19) United States
(12) Patent Application Publication
(10) Pub. No.: US 2011/0081636 A1
(43) Pub. Date: Apr. 7, 2011

(54) Dual gender cancer teaching kit

(76) Inventors: Lyle Ashley Wilkes, Castle Rock, CO (US); Mary Wilkes, Castle Rock, CO (US)

(21) Appl. No.: 12/587,411

(22) Filed: Oct. 7, 2009

(51) Int. Cl. G09B 23/30

(52) U.S. Cl. 434/267

(57) ABSTRACT

This product is a dual gender teaching kit (The Kit) for breast and testicular cancer examination, comprising of a soft silicone material with artificial cancerous nodules and an accompanying compact disk containing automated examination instructions. The female cancer sample will contain multiple sized acrylic nodules embedded within the silicone body. The male cancer sample will contain an acrylic testicle with an abscessed deformity as well as a small sized acrylic nodule. The silicone samples will be attached to a base and packaged within a heavyweight paper sleeve which will also house an instructional compact disk for both the breast and testicular self-examination.

### REFERENCES CITED

U.S. Patent Documents

| | | |
|---|---|---|
| 4,001,951 | January 1977 | Fasse |
| 413,418 | January 1979 | Adams et al. |
| 4,867,686 | September 1989 | Goldstein |
| 5,273,435 | December 1993 | Jacobson |
| 6,575,757 | June 2003 | Leight et al. |
| 6,854,976 | October 2003 | Suhr |

### FIELD OF INVENTION

This invention interacts in relation to a breast cancer lump and a testicular cancer lump simulator and training kit.

### BACKGROUND OF THE INVENTION

### Female Breast Cancer

Breast cancer is the most common cancer in women in the United States and is the second leading cause of cancer death in women after lung cancer. According to the American Cancer Society, it's estimated that 178,480 women in the United States will be found to have invasive breast cancer in 2008. Approximately 40,500 women will die annually. As of this patent, there are slightly over 2 million women living in the United States who have been treated for breast cancer.

Aggressive breast cancer can grow twice its size every three days. Within as little as three months a single cancer cell can double thirty times and produce a one centimeter size cancerous tumor (lump). Breast cancer can grow to four centimeters in diameter (stage III to stage IV) in a nine month period. Many times lumps are discovered in between a female's annual clinical exam. About 1 in 8 women in the United States will develop breast cancer. Approximately 40,500 women will die annually.

With alarming statistics growing each year, there is a need to educate women starting as young as 20 years old on how to conduct self-examinations. This invention provides both instructional materials and samples of what to feel for during self-examinations in the privacy of one's own home.

### Male Testicular Cancer

The American Cancer Society estimates that about 8,090 new cases of testicular cancer will be diagnosed during 2008 in the United States. Statistics show that on the average 400 men die each year from testicular cancer. The rate of testicular cancer has been increasing in many countries, including the United States.

Education will be the continuing key factor in assisting young men ages 15 to 35 years old help recognize the potential dangers of testicular cancer.

This invention provides both instructional materials and samples of what to feel for during self-examinations in the privacy of one's own home.

### Compact Disk (CD)

Currently there is not a CD on the market which contains animated instructions in multiple languages concerning the female and male cancer self-examination, except for this invention. In addition to the self-examination instructions, the CD will also educate all users through online demonstrations, internet links to cancer subject matters and cancer-related organizations.

### SUMMARY OF THE INVENTION

The Dual Gender Cancer Teaching Kit will provide a quality teaching aid for both men and women of all ages to tactically experience what a cancer tumor may feel like in either the breast or the testicle. It is the inventors hope that The Kit will save lives through early detection and users seeking medical attention.

The product will be contained in an outer sleeve measuring approximately 5″×5½″× 6/8″ and an inner sleeve measuring approximately 4⅞″×5 7/16″×½″ on 18 point paper. As you remove the outer sleeve and open the inner sleeve, it will contain a model and information on female breast cancer and a model and information on male testicular cancer. Both models will be the same dimension of 3″×1¼×½″.

The two samples will be made from silicon to create a realistic representation of human tissue. It will be flat on the bottom and rectangular in shape. Inside the simulated breast model will be two different sized acrylic nodules that will be inserted into two different locations to represent cancer lumps. On the male side, the silicon will contain a simulated testicle which will feature an abscessed deformity as well as a small sized acrylic nodule to represent cancer lumps.

### Symptoms of Breast Cancer

The most common sign of breast cancer for both men and women is a lump or Other potential signs of breast cancer include: thickening in the breast. Often, the lump is painless.
A spontaneous clear or bloody discharge from the nipple, often associated with a breast lump
Retraction or indentation of the nipple
A change in the size or contours of the breast
Any flattening or indentation of the skin over the breast
Redness or pitting of the skin over the breast, like the skin of an orange
   A number of conditions other than breast cancer can cause your breasts to change in size or feel. Breast tissue changes naturally during pregnancy and your menstrual cycle. Other possible causes of noncancerous (benign) breast changes include fibrocystic changes, cysts, fibroadenomas, infection or injury.

The Dual Gender Cancer Teaching Kit will help teach not only women, but health care professionals and educators about breast cancer self-exams and possible early detection of breast cancer.

### Symptoms of Testicular Cancer

Many men with testicular cancer will not feel ill and may report no symptoms. It's also important to remember that other, benign conditions can cause the symptoms listed below. However, since early stage testicular cancer is curable, men should see a doctor if they have any of the warning signs or symptoms of testicular cancer.

Other symptoms and signs of testicular cancer include:
A painless lump or swelling in a testicle
Pain or discomfort in a testicle or in the scrotum
Any enlargement of a testicle or change in the way it feels
A feeling of heaviness in the scrotum
A dull ache in the lower abdomen, back, or groin
A sudden collection of fluid in the scrotum

The Dual Gender Cancer Teaching Kit will help teach not only men, but health care professionals and educators about testicular cancer self-exams and possible early detection of cancer.

### Breast Self-Examination (BSE)

If performed appropriately and regularly BSE may help in early detection of some types of breast cancers, although it should not substitute for screening methods (such as mammography) that have been proven to be effective. There are three different methods involving feeling breasts for possible distortions or swelling. Women using the pads of the fingers gently feel the breasts, giving special attention to their shape, size and texture for any lumps. Women should become very familiar with their breast in size, shape and appearance and the feel of her breasts and should become aware of any changes that take place. The best time for women to perform a BSE is at the end of their menstrual cycle when their breasts are less tender.

The Kit will contain a compact disk with illustrated instructions on how to conduct the BSE and will contain the information from the section above.

### Testicular Self-Examination (TSE)

Performing monthly testicular self-exams is recommended for all males after reaching puberty, generally around 13 years of age. The best time to perform the self-exam is during or after a bath or shower, when the skin of the scrotum is relaxed. To perform the exam, men should examine each testicle separately by rolling it gently between the thumb and fingers. They should look and feel for hard lumps or masses or changes in size, shape, or consistency of the testes.

The Kit will contain a compact disk with illustrated instructions on how to conduct the testicular self-exam and will contain the information from the section above.

### BRIEF DESCRIPTION OF THE DRAWINGS

FIG. 1 Side view of the folded teaching kit.

FIG. 2 Kit outer sleeve.

FIG. 3 Kit inner sleeve.

FIG. 4 Kit inner sleeve showcasing the female breast model and self-examination information.

FIG. 5 Kit inner sleeve showcasing the male testicular model and self-examination information, as well as the inside pocket for housing the CD.

FIG. 6 Top view of the female breast simulation showing anchor placement for acrylic nodules.

FIG. 7 Side view of the female breast simulation showing anchor placement for acrylic nodules.

FIG. 8 Top view of the male testicle simulation showing anchor placement for acrylic nodules.

FIG. 9 Side view of the male testicle simulation showing anchor placement for acrylic nodules.

FIG. 10 Top view of the male testicle model simulation detailing tumor and cyst placement.

### DETAILED DESCRIPTION OF THE DRAWINGS

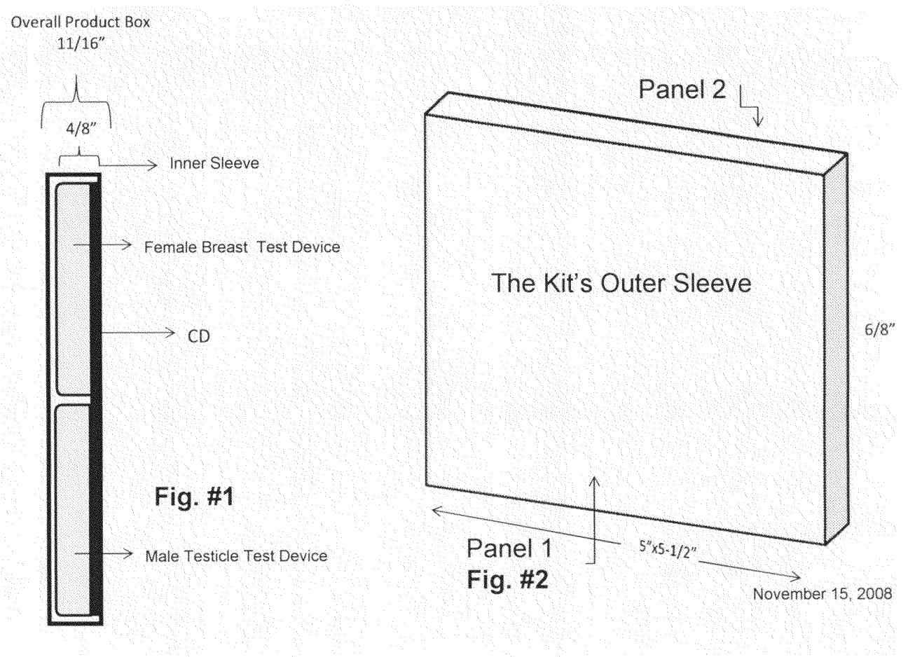

FIG. 1 The Kit in a closed position with the female model on top, male model on bottom and the CD packaged behind. The overall product width is 11/16″ allowing the outer sleeve to slip over the inner core sleeve measuring only 4/8″.

FIG. 2 Kit outer sleeve measurements of 5″×5½″× 6/8″. Paper weight will be 18 pt.

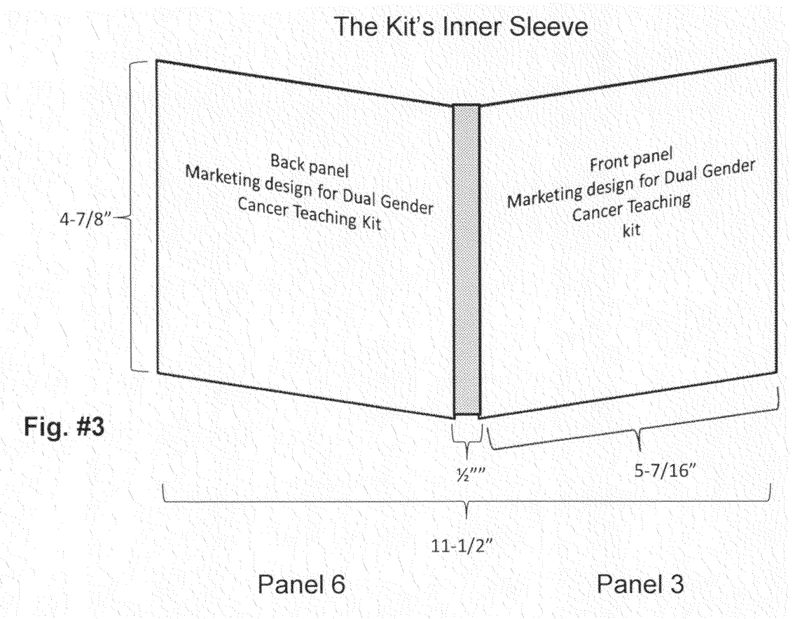

FIG. 3 Kit inner sleeve and reverse side of FIG. 4 measuring 11½″. Each panel measures 5 7/16″ ×4⅞″ with a ½″ spine between them. Paper weight will be 18 pt.

FIG. 4 Reverse side of FIG. 3. Panel #4 contains the female model measuring 3″×1¼″×½″ made of simulated tissue with self-examination instructions.

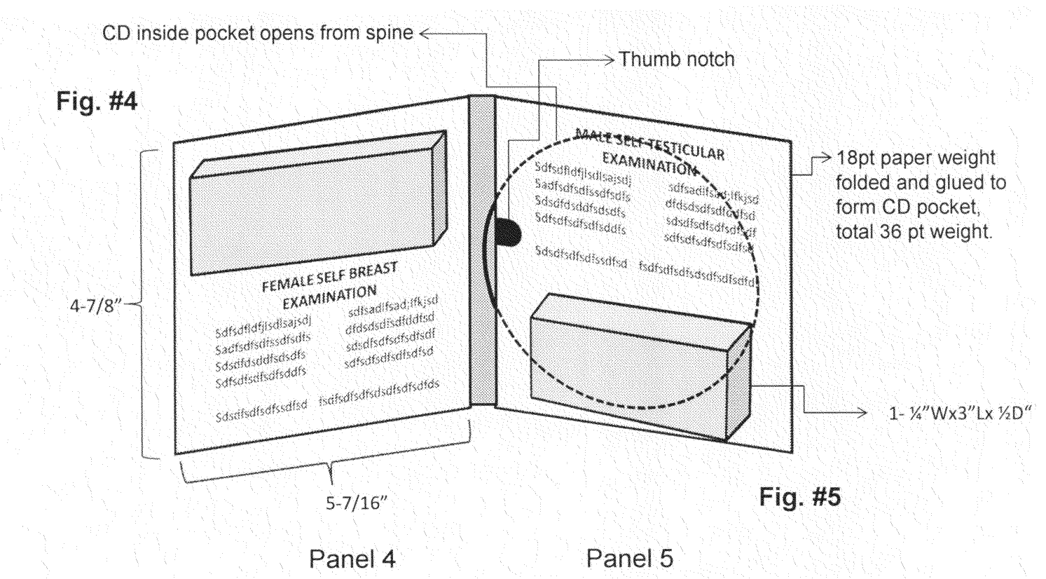

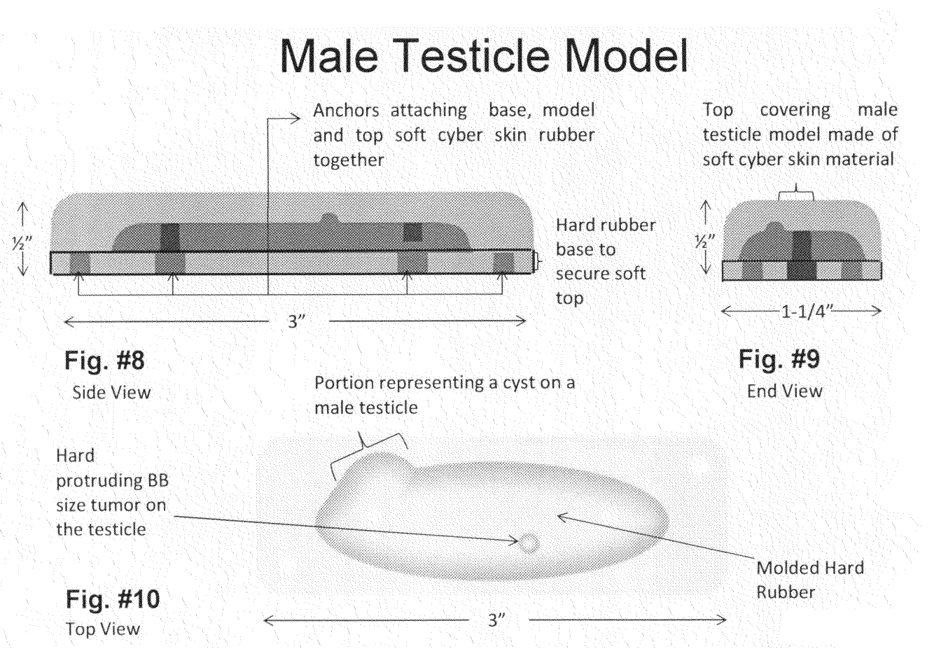

FIG. 5 Male model measuring 3″×1¼″×½″ made of simulated tissue with self-examination instructions. Further details of this model will be explained in FIGS. 8, 9 & 10. Located behind the male model is a pocket containing a 4¾″ Compact Disk. This CD will contain a combination of both female and male breast and testicle self-examinations in high definition 3D animation which will also be spoken in multiple languages. This CD will educate both men and women in understanding Breast Cancer or Testicular Cancer through on line demonstrations, internet links directing them to cancer subject matters and to cancer related organizations.

FIG. 6 Top view of the female model measuring 3″ in length and ½″ in height. The top portion of the model is covered in a soft opaque plastic covering the two different acrylic nodules representing cancerous lumps. The two nodules are attached to two flexible posts varying in height, which are attached to a hard rubber base.

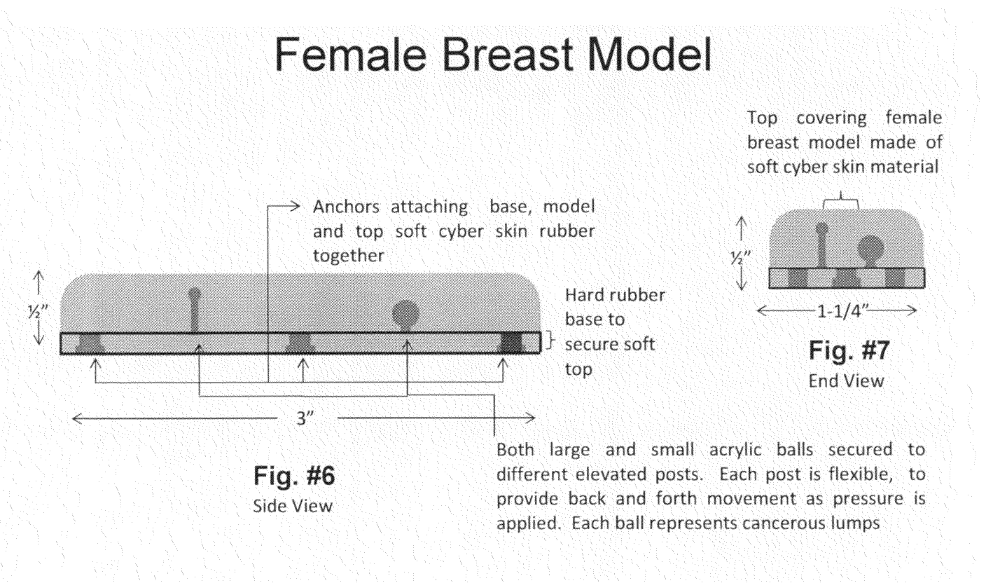

FIG. 7 End view of the female model measuring ½″ in height by 1¼″ wide, detailing the placement of the acrylic nodules.

FIG. 8 Top view of the male model measuring 3″ in length and ½″ in height. The top portion of the model is covered in a soft opaque plastic covering the molded plastic testicle with acrylic nodule on the testicle and a protruding cyst that representing potential cancer. The molded plastic testicle is attached to a hard rubber base and secured with three small rubber anchors.

FIG. 9 End view of the male model measuring ½″ in height by 1¼″ wide, detailing the placement of the simulated testicle and acrylic nodule.

FIG. 10 Top view of the male model measuring 3″ in length and 1¼″ in width, detailing the testicle with the cancerous lump and cyst. The model is covered in soft opaque plastic.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

We claim:

1. A teaching aid compromising of: a soft model of a human breast; a plurality of imitation lumps embedded within the breast model; a soft model of a human testes; a plurality of imitation lumps embedded within the human testes model; said human breast model and said human testes model mounted on a pliable surface.

2. The apparatus of claim 1, wherein the pliable surface is divided into two separate parts. One part of said pliable surface will house the human breast model and one part of said pliable surface will house the human testes model.

3. The apparatus of claim 2, wherein the part housing the human breast model contains written breast self-examination instructions and the part housing the human testes model contains written testes self-examination instructions.

4. The apparatus of claim 3, wherein a compact disc (CD) containing breast self-examination instructions and testes self-examination instructions, in multiple languages, is embedded within the pliable surface.
